(19) United States
(12) Patent Application Publication
(10) Pub. No.: US 2023/0057506 A1
(43) Pub. Date: Feb. 23, 2023

(54) LOW LATENCY AUTOMIXER INTEGRATED WITH VOICE AND NOISE ACTIVITY DETECTION

(71) Applicant: Shure Acquisition Holdings, Inc., Niles, IL (US)

(72) Inventors: Ross Lawrence Penniman, Skokie, IL (US); Michael Ryan Lester, Colorado Springs, CO (US); Michelle Michiko Ansai, Chicago, IL (US); Michael Harrison Prosinski, Chicago, IL (US); Wenshun Tian, Palatine, IL (US); David Andrew VerLee, Libertyville, IL (US)

(21) Appl. No.: 17/717,584

(22) Filed: Apr. 11, 2022

Related U.S. Application Data
(63) Continuation of application No. 16/887,407, filed on May 29, 2020, now Pat. No. 11,302,347.
(60) Provisional application No. 62/855,491, filed on May 31, 2019.

(51) Int. Cl. G10L 25/78; G10L 21/0208; H04R 3/04; H04R 5/04; H04S 7/00; G10L 21/0364; G10L 21/02; G10L 21/0316

(52) U.S. Cl. CPC G10L 25/78; G10L 21/0208; H04R 3/04; H04R 5/04; H04S 7/307; G10L 21/0364; G10L 21/02; G10L 21/0316; G10L 2021/03643; G10L 2021/03646

(57) ABSTRACT

Systems and methods are disclosed for providing voice and noise activity detection with audio automixers that can reject errant non-voice or non-human noises while maximizing signal-to-noise ratio and minimizing audio latency.

### CROSS-REFERENCE TO RELATED APPLICATION

This application is a continuation of U.S. patent application Ser. No. 16/887,407, filed on May 29, 2020, which claims the benefit of U.S. Provisional Pat. App. No. 62/855,491, filed on May 31, 2019, both of which are incorporated by reference herein in their entireties.

### TECHNICAL FIELD

This application generally relates to systems and methods for providing low latency voice and noise activity detection integrated with audio automixers. In particular, this application relates to systems and methods for providing voice and noise activity detection with audio automixers that can reject errant non-voice or non-human noises while maximizing signal-to-noise ratio and minimizing audio latency.

### BACKGROUND

Conferencing and presentation environments, such as boardrooms, conferencing settings, and the like, can involve the use of multiple microphones or microphone array lobes for capturing sound from various audio sources. The audio sources may include human speakers, for example. The captured sound may be disseminated to a local audience in the environment through amplified speakers (for sound reinforcement), and/or to others remote from the environment (such as via a telecast and/or a webcast). Each of the microphones or array lobes may form a channel. The captured sound may be input as multi-channel audio and provided as a single mixed audio channel.

Typically, captured sound may also include errant non-voice or non-human noises in the environment, such as sudden, impulsive, or recurrent sounds like shuffling of paper, opening of bags and containers, chewing, typing, etc. To minimize errant noise in captured sound, voice activity detection (VAD) algorithms and/or automixers may be applied to the channel of a microphone or array lobe. An automixer can automatically reduce the strength of a particular microphone's audio input signal to mitigate the contribution of background, static, or stationary noise when it is not capturing human speech or voice. VAD is a technique used in speech processing in which the presence or absence of human speech or voice can be detected. In addition, noise reduction techniques can reduce certain background, static, or stationary noise, such as fan and HVAC system noise. However, such noise reduction techniques are not ideal for reducing or rejecting errant noises.

While the combination of automixing and VAD exists in current systems, such combinations are not typically inherently capable of rejecting errant noises, in particular with low audio latency that is capable of real-time communication or for use with in-room sound reinforcement. The rejection of errant noises may compromise the performance of typical automixers since automixers typically rely on relatively simple channel selection rules, such as the first time of arrival or the highest amplitude at a given moment in time. Current systems that integrate automixing and VAD may not be optimal due to high latency and/or front end clipping (FEC) of speech or voice. For example, additional audio latency can be added to a channel to align the detection delay of a VAD to the incidence of voice in order to minimize FEC to the syllables or words in the speech or voice, but this may result in unacceptable delays in the audio stream. Alternatively, FEC can be accepted by deciding to not add audio latency to align the VAD detection delay to the audio stream, but this may result in incomplete voice or speech in the audio stream. These situations may result in decreased user satisfaction. Moreover, many current systems with VAD may utilize only a single audio channel in which the spatial relationship of speech/voice and noise that occurs in the particular environment need not be considered for effective operation.

Furthermore, in an automixing application (either with separate microphone units or using steered audio lobes from a microphone array), voice and errant noises may occur in the same environment and be included in all microphones and/or lobes, due to the imperfect acoustic polar patterns of the microphones and/or the lobes. This may present problems with VAD detection capability (both on an individual channel and collective channel basis), appropriate automixer channel selection (which attempts to avoid errant noises while still selecting the channel(s) containing voice), and the suppression of errant noises in lobes that are gated on because they contain speech/voice.

Accordingly, there is an opportunity for systems and methods that address these concerns. More particularly, there is an opportunity for systems and methods that can provide voice and noise activity detection with audio automixers that can reject errant non-voice or non-human noises while maximizing signal-to-noise ratio, increasing intelligibility, minimizing audio latency, and increasing user satisfaction. By combining automixing principles with more advanced voice activity detection techniques, microphone/lobe selection can be enhanced to maximize speech-to-errant noise ratios.

### SUMMARY

The invention is intended to solve the above-noted problems by providing systems and methods that are designed to, among other things: (1) utilize a modified voice activity detector altered to function as a noise activity detector to sense whether voice or errant noise is present on a channel; (2) perform additional channel gating based on metrics and decisions from the voice activity detector that may affect and/or override the channel gating performed by an automixer; (3) reduce or eliminate the amount of front end clipping of captured voice/speech; and (4) minimize the effects of front end noise leak from errant noises that may be initially included in a particular gated on channel.

In an embodiment, a method includes determining whether non-speech audio is present in an audio signal of a channel initially gated on by a mixer, where the mixer generates a mixed audio signal based on at least the audio signal of the channel initially gated on; and when the non-speech audio is determined to be present in the audio signal of the channel initially gated on, overriding the mixer by gating off the channel initially gated on to cause the mixer to generate the mixed audio signal without the audio signal of the channel initially gated on.

In another embodiment, a system includes an activity detector configured to determine whether non-speech audio is present in an audio signal of a channel initially gated on by a mixer, where the mixer is configured to generate a mixed audio signal based on at least the audio signal of the channel initially gated on. The system also includes a channel gating module in communication with the activity detector, and the channel gating module is configured to when the non-speech audio is determined by the activity detector to be present in the audio signal of the channel initially gated on, override the mixer to cause the mixer to gate off the channel initially gated on, and generate the mixed audio signal without the audio signal of the channel initially gated on.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a system including a mixer and a voice activity detector for gating of channels, in accordance with some embodiments.

FIG. 2 is a flowchart illustrating operations for gating channels from microphones using the system of FIG. 1, in accordance with some embodiments.

FIG. 3 is a diagram of an exemplary gate control state machine used in the mixer of the system of FIG. 1, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The systems and methods described herein can generate a mixed audio signal from an automixer that reduces and minimizes the contributions from errant non-voice or non-human noises that are sensed in an environment. The systems and methods may utilize an automixer in conjunction with a voice activity detector (or errant noise activity detector) that each make independent channel gating decisions. The automixer may gate particular channels on or off based on channel selection rules, while the voice/errant noise activity detector may override the channel gating decisions of the automixer depending on whether voice or errant noise is detected in channels that were gated on by the automixer. Metrics from the voice/errant noise activity detector, such as a confidence score, may also affect the channel gating decisions and/or affect the relative chosen mixture of each channel in the automixer. To support a low latency audio output, some errant noises may leak into the audio mix before the voice/errant noise activity detector is able to override the audio mixer. The systems and methods may allow for this behavior while minimizing the energy and subjective audio quality impact of this channel gating noise onset. This allows the energy from errant noises that leak into channels to be minimized while maintaining low latency.

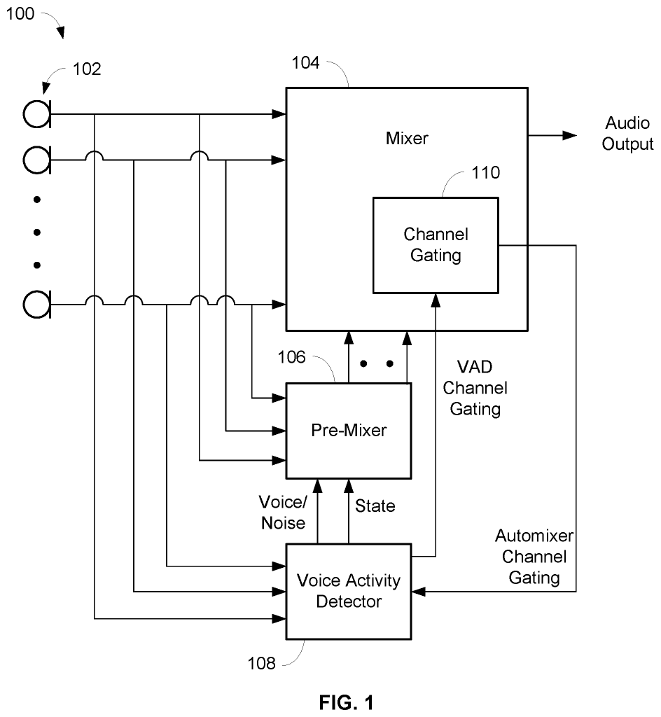

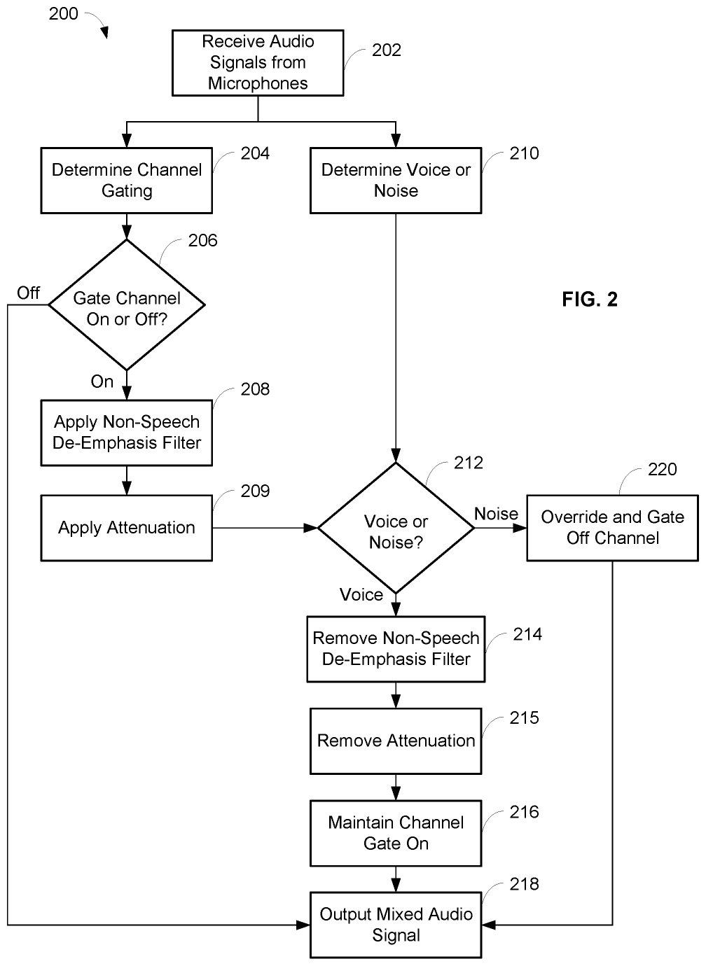

FIG. 1 is a schematic diagram of a system 100 that can be utilized to reject errant noises, including microphones 102, a mixer 104 and a voice activity detector 108. FIG. 2 is a flowchart of a process 200 for rejecting errant noises using the system 100 of FIG. 1. The system 100 and the process 200 may result in the output of a mixed audio signal with optimal signal-to-noise ratio and that includes desirable voice while minimizing the inclusion or contribution of errant noises.

Environments such as conference rooms may utilize the system 100 to facilitate communication with persons at a remote location, for example. The types of microphones 102 and their placement in a particular environment may depend on the locations of audio sources, physical space requirements, aesthetics, room layout, and/or other considerations. For example, in some environments, the microphones may be placed on a table or lectern near the audio sources. In other environments, the microphones may be mounted overhead to capture the sound from the entire room, for example. The communication system 100 may work in conjunction with any type and any number of microphones 102. Various components included in the communication system 100 may be implemented using software executable by one or more servers or computers, such as a computing device with a processor and memory, graphic processing units (GPUs), and/or by hardware (e.g., discrete logic circuits, application specific integrated circuits (ASIC), programmable gate arrays (PGA), field programmable gate arrays (FPGA), etc.

In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

Referring to FIG. 1, the system 100 may include the microphones 102, the mixer 104, a pre-mixer 106, a voice activity detector 108, and a channel gating module 110. Each of the microphones 102 may detect sound in the environment and convert the sound to an audio signal and form a channel. In embodiments, some or all of the audio signals from the microphones 102 may be processed by a beamformer (not shown) to generate one or more beamformed audio signals, as is known in the art. Accordingly, while the systems and methods are described herein as using audio signals from microphones 102, it is contemplated that the systems and methods may also utilize any type of acoustic source, such as beamformed audio signals generated by a beamformer.

The audio signals from each of the microphones 102 may be received by the mixer 104, the pre-mixer 106, and the voice activity detector 108, such as at step 202 of the process 200 shown in FIG. 2. The mixer 104 may ultimately generate and output a mixed audio signal that may conform to a desired audio mix such that the audio signals from certain microphones are emphasized and the audio signals from other microphones are deemphasized or suppressed. Exemplary embodiments of audio mixers are disclosed in commonly-assigned patents, U.S. Pat. Nos. 4,658,425 and 5,297,210, each of which is incorporated by reference in its entirety.

The mixed audio signal from the mixer 104 may include contributions from one or more channels, i.e., audio signals from the microphones 102, that are gated on using the system 100. The mixer 104 and the channel gating module 110 may gate on one or more channels to provide captured audio without suppression (or in certain embodiments, with minimal suppression) in response to determining that the captured audio contains human speech and/or according to certain channel selection rules. The mixer 104 and the channel gating module 110 may also gate off one or more channels to reduce the strength of certain captured audio in response to determining that the captured audio in a channel is a background, static, or stationary noise. The determination of channel gating by the mixer 104 and the channel gating module 110 may occur at step 204. The mixer 104 and the channel gating module 110 may render a channel gating decision for each of a plurality of channels corresponding to the plurality of microphones or array lobes 102. The process 200 may continue to step 206.

At step 206, if a channel was determined to be gated off at step 204, then process 200 may proceed to step 218 and the mixer 104 may output a mixed audio signal that does not include the gated off channel. However, if at step 206 a channel was determined to be gated on at step 204, then the process 200 may continue to step 208, where in certain embodiments a non-speech de-emphasis filter may be applied which functions as a bandwidth limiting filter (such as a low pass filter, a bandpass filter, or linear predictive coding (LPC)) to subjectively minimize front end noise leakage, as described in further detail below.

The audio signals from the microphones 102 may also be received at step 210 by the voice activity detector (VAD) 108. The VAD 108 may execute an algorithm at step 210 to determine whether there is voice present in a particular channel or conversely, whether there is noise present in a particular channel. For example, if voice is found to be present in a particular channel (or noise is not found) by the VAD 108, then the VAD 108 may deem that that channel includes voice or is “not noise”. Similarly, if voice is not found to be present in a particular channel (or noise is found) by the VAD 108, then it may be deemed that that channel includes noise or is “not voice”. In embodiments, the VAD 108 may be implemented by analyzing the spectral variance of the audio signals, using linear predictive coding (LPC), applying machine learning or deep learning techniques to detect voice, and/or using well-known techniques such as the ITU G.729 VAD, ETSI standards for VAD calculation included in the GSM specification, or long term pitch prediction.

By identifying whether a particular channel contains errant noise (i.e., is “not voice”), the system 100 can override decisions made by the mixer 104 and the channel gating module 110 to gate on channels and subsequently gate off such channels so that errant noise is not ultimately included in the mixed audio signal output from the mixer 104. In particular, at step 212, if it was determined that there is errant noise in a channel at step 210, then the process 200 may continue to step 220. At step 220, the decision by the mixer 104 and the channel gating module 110 to gate on the channel may be overridden due to the detection of errant noise, and the channel may be gated off. The process 200 may continue to step 218 where the mixer 104 may output a mixed audio signal that does not include contributions from the now-gated off channel. In embodiments, a confidence score from the VAD 108 may be utilized to determine whether the decision by the mixer 104 to gate on the channel may be overridden to gate the channel off, and/or be utilized to affect the relative chosen mixture of each channel in the automixer.

However, at step 212, if it was determined that there is voice (i.e., “not noise”) in the channel at step 210, then the process 200 may continue to step 214. At step 214, the filter applied at step 208 may be removed, as described in more detail below. At step 216, the gating on of the channel may be maintained by the mixer 104, and at step 218, the mixer 104 may output a mixed audio signal that includes this channel.

In embodiments, steps 210 and 212 by the VAD 108 for identifying whether there is voice or noise in a channel may be performed in parallel or just after the mixer 104 and the channel gating module 110 have determined channel gating decisions at steps 204 and 206. For example, the VAD 108 may collect and buffer audio data from the input audio signals for a predetermined period of time in order to have enough information to determine whether the channel includes voice or noise. As such, in the time period between the decision of the mixer 104 and the decision of the VAD 108 (regarding whether to override or not override the decision of the mixer 104 and the channel gating module 110), errant noise may temporarily contribute to the mixed audio signal. This contribution of errant noise for a small time period may be termed as front end noise leak (FENL). The occurrence of FENL in a mixed audio signal may be deemed as more desirable and less apparent to listeners of the mixed audio signal, as compared to front end clipping. The subjective impact of allowing FENL can be minimized through control of the amplitude and frequency content of the FENL time period, and the chosen length of time that FENL is allowed.

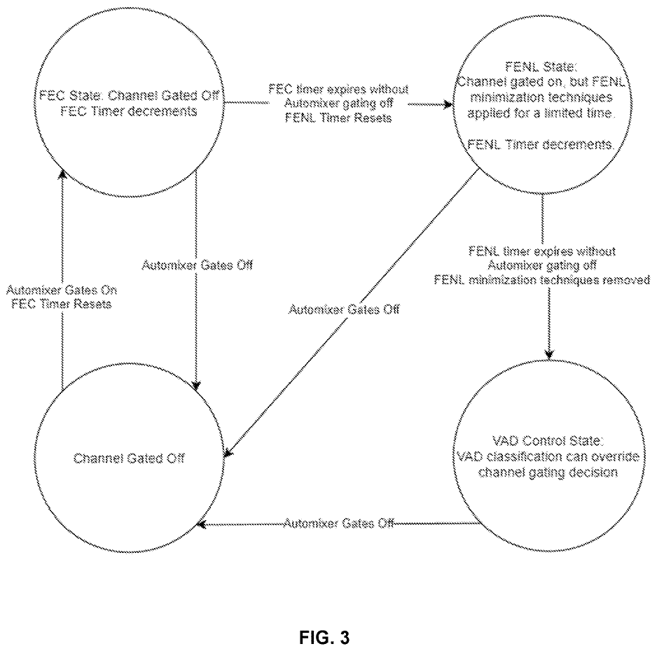

In embodiments, the mixer 104 may include a gate control state machine that controls the final application of channel gating based on the decisions of the mixer 104, the channel gating module 110, and the VAD 108. The state machine may include: (1) an FEC time period which is controlled by algorithm design outside of the design of the mixer 104 and the channel gating module 110 that delays the gate on time; (2) a particular duration during the FENL time period in which the mixer 104 and the channel gating module 110 have full control over channel gating; and/or (3) and a final time period in which the gating indication from the VAD 108 may be logically ANDed with the gating indication from the mixer 104 and the channel gating module 110. When the gating indication of the mixer 104 and the channel gating module 110 returns to gate off for a channel, the gate control state machine may be returned to its starting condition. A depiction of the gate control state machine is shown in FIG. 3.

The contribution of FENL to the mixed audio signal may be minimized using various techniques as detailed below by minimizing the energy and spectral contribution of errant noise that may temporarily leak into a particular channel. The minimization of the contribution of FENL to the mixed audio signal may reduce the impact on speech and voice in the mixed audio signal during the time period when FENL may occur. Such FENL minimization techniques may be implemented in the pre-mixer 106, in some embodiments.

The pre-mixer 106 may receive state information from the voice activity detector 108, in some embodiments. The state information may include a combination of automixer gating flags, VAD/NAD indicators, and the FENL time period. The pre-mixer 106 may utilize the state information to determine the amplitude attenuation and frequency filtering to apply over time. The mixer 104 may receive processed audio signals from the pre-mixer 106. The number of processed audio signals from the pre-mixer 106 to the mixer 104 may be the same as the number of microphones 102 in some embodiments, or may be less than the number of microphones 102 in other embodiments.

One technique may include applying an attenuated gate on amplitude until the VAD 108 can positively corroborate the decision by the mixer 104 to gate on a channel. The attenuation of a channel during the FENL time period can reduce the impact of errant noise while having a relatively insignificant impact on the intelligibility of speech in the mixed audio signal. This technique may be implemented in the pre-mixer 106 by applying a simple attenuation to channels that the automixer has recently gated on within the FENL time period window at step 209 and removing the application of the attenuation at step 215. The FENL time period window is exited after a timer expires that corresponds to the length of time that noise is allowed to leak through without tangibly affecting the subjective audio quality of speech.

Another technique may include reducing the audio bandwidth during the FENL time period. The reduction of audio bandwidth in this scenario can maintain the most important frequencies for intelligibility of speech or voice in the mixed audio signal during the FENL time period, while significantly reducing the impact of having a certain time period (e.g., some number of milliseconds) of full-band FENL. This technique may be implemented in the pre-mixer 106 by applying the non-speech de-emphasis filter at step 208 and removing the application of the non-speech de-emphasis filter at step 214, as described above. For example, a low pass filter may be applied at step 208 after the mixer 104 has made a decision as to whether to gate a channel on or off (e.g., at steps 204 and 206), but prior to the decision by the VAD 108 as to whether there is voice or noise in a channel. Once the VAD 108 has made a decision that there is voice in a channel (e.g., at steps 210 and 212), then the application of the non-speech de-emphasis filter may be removed at step 214. In embodiments, the non-speech de-emphasis filter in the pre-mixer 106 may be a static second order Butterworth filter that is cross-faded with the unprocessed audio signal from the microphones 102. In other embodiments, the non-speech de-emphasis filter in the pre-mixer 106 may be implemented as two first-order low pass filters in series where more or less filtering can be applied by moving the location of the pole of the filter over time, which provides control of limiting the bandwidth of the low and high frequencies independently and adaptively over time. Adaptive control of these filters can correspond to the FENL timer parameter or VAD confidence metrics. In other embodiments, the non-speech de-emphasis filter in the pre-mixer 106 may be implemented as a more complex bandwidth limiting filter that preserves the formant structure of speech by employing linear predictive coding.

Another technique may include altering the crest factor of the audio to minimize the perception of noise. Many types of errant noises may have higher crest factors than human speech. A sustained high crest factor can be perceived as loudness by a human. By compressing the crest factor of the audio during the FENL region to equal to or below that of human speech, the intelligibility of human speech can be maintained while reducing the perceived loudness of an errant noise. In some embodiments, signals with an instantaneous time domain crest factor that is above a target can be dynamically compressed to maintain the desired crest factor. In other embodiments, the compression can be modified to be a limiter to further ensure that the resulting audio has the desired crest factor.

A further technique may include introducing a predetermined amount of FEC that can psychoacoustically minimize the subjective impact of sharply transient errant noises (e.g., pen clicks, books dropping on a table, etc.) while insignificantly impacting the subjective quality of voice (which usually does not exhibit a transient onset). The introduction of FEC in this situation can be further refined to mimic the inverse envelope of a transient errant noise, which can noticeably reduce noise perception while not completely removing the onset of speech that would occur with a static attenuation during the FENL time period. This can be implemented in step 209 and removed in step 215 by applying a time varying, rather than static, attenuation. By using one or more of these techniques, the impact of errant noise leaking into the mixed audio signal undetected may be minimized until the VAD 108 can make a decision as to whether there is voice or noise in the channel. This can accordingly provide a benefit to speech intelligibility without adding audio path latency.

The FENL minimization techniques described above can be enhanced through the use of adaptive techniques that can automatically modify behaviors that better match the environment in which the system 100 is operating. Such adaptive techniques may control the time parameters of the gate control state machine described above, as well as parameters such as inverse FEC envelope shape, bandwidth reduction values, the amount of attenuation during the FENL time period, FENL minimization temporal entrance/exit behaviors, and/or temporal ballistics of the mixer 104 to gate off a channel that the VAD 108 has identified as containing errant noise.

In embodiments, the system 100 may collect statistics for each channel (corresponding to each of the plurality of microphones or array lobes 102) to identify whether a particular channel on average contains voice/speech or noise. For example, in a particular environment one channel may be pointed toward a door, while another channel is pointed at a chairman position. In this environment, over time, the system 100 may determine that the channel pointed at the door is almost exclusively errant noise and that the channel pointed at the chairman position is almost exclusively voice. In response, the system 100 may tune the channel pointed toward the door to apply longer forced FEC, use more aggressive FENL minimization parameters, and/or cause the gate control state machine to give additional priority to the VAD 108 with regards to gating decisions. Conversely, the system 100 may tune the channel pointed toward the chairman position to eliminate FEC, reduce the use of FENL minimization techniques, and/or cause the gate control state machine to provide gating control to the mixer 104 for a longer period of time (which may in turn force the VAD 108 to be more confident in its decision regarding noise before overriding and gating off the channel).

Another technique may include the system 100 only allowing adaptations to train when the VAD 108 has reached a threshold level of high confidence on a particular channel. This may mitigate false positives and/or false negatives in the adaptation behavior as applied to the FENL minimization techniques. A further technique may include the system 100 sampling and analyzing audio envelope data of a gated on channel for an audio period that was subsequently tagged as noise by the VAD 108, in order to update the inverse FEC envelope shape described above.

In embodiments, adaptive behavior may also be applied to the process of gating off a channel. For example, during normal speech, the system 100 may apply a slow ramp out for gating off a channel in order to minimize the perception of the noise floor of the audio going up and down or changing. As another example, in the presence of noise, the system 100 may apply a fast ramp for gating off a channel in order to maximize the effectiveness of gating channels off in response to a decision by the VAD 108. In embodiments, the system 100 may combine information from the mixer 104 and the VAD 108 to determine the reason for gating off a channel. This information may be used to dynamically alter the speed at which a channel is gated off. In addition, non-uniform slopes of the ramp can be used to perceptually optimize both the errant noise and speech conditions.

The system 100 may include further techniques that address the imperfect audio selectivity between the microphones or lobes 102, which can result in many or all channels having both voice and errant noise. In this situation, simply gating off a particular channel that contains the highest amount of errant noise may not fully eliminate the errant noise from the mixed audio signal. This may result in some of the errant noise still being present in the gated on channel that contains voice. One technique to address this situation may include the use of a noise leakage filter in the pre-mixer 106. The noise leakage filter may be applied during the portion of time after the VAD 108 has made a decision that there is voice in a particular channel. If it has been determined that a different channel includes errant noise (i.e., the decision of the mixer 104 to gate on that different channel has been overridden by the VAD 108), then the noise leakage filter may be applied to the channel having voice in order to mitigate high frequency leakage of noise into the channel having voice. In other words, the noise leakage filter may be applied when there is at least one channel identified as including errant noise while there are other channels identified as not having errant noise (i.e., having voice). In embodiments, the noise leakage filter in the pre-mixer 106 may be a static second order Butterworth filter that is cross-faded with the unprocessed audio signal from the microphones 102. In other embodiments, the noise leakage filter in the pre-mixer 106 may be implemented as two first-order low pass filters in series where more or less filtering can be applied by moving the location of the pole of the filter over time, which provides control of limiting the bandwidth of the low and high frequencies independently and adaptively over time. Adaptive control of these filters can correspond to the number of other channels identified as noise or VAD confidence metrics. In other embodiments, the noise leakage filter in the pre-mixer 106 may be implemented as a more complex bandwidth limiting filter that preserves the formant structure of speech by employing linear predictive coding.

For example, typically when a particular channel is gated off by the mixer 104, the mixer 104 may attenuate the audio signal in that channel (e.g., by applying −15 dB attenuation) in order to preserve room presence, have noise floor consistency as various channels are gated on and off, and to reduce the impact of FEC on a channel that is gated on late. By using the noise leakage filter described above, the system 100 may reduce the bandwidth of channels that are gated on such that the frequencies for speech intelligibility are preserved, while the frequencies for errant noise are rejected. This may result in mitigating the errant noise leaking into the channels that are gated on.

In certain embodiments, to further reduce the contribution of errant noise, when one or more channels are identified as containing errant noise by the VAD 108, the system 100 may apply an additional attenuation (i.e. changed from −15 dB to −25 dB) to all gated off channels and reduce the bandwidth of these channels.

It should be noted that standard static noise reduction techniques may be utilized in the system 100. In embodiments, the VAD 108 may utilize audio signals from the microphones 102 that have not been noise reduced. It may be more optimal for the VAD 108 to use non-noise reduced audio signal so that the VAD 108 can make its decisions based on the original noise floor of the audio signals.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1-21. (canceled)

22. A method, comprising:
determining whether non-speech audio is present in an audio signal of a channel initially gated on by a mixer, wherein the mixer generates a mixed audio signal based on at least the audio signal of the channel initially gated on; and
based on determining that the non-speech audio is present in the audio signal of the channel initially gated on, overriding the mixer by gating off the channel initially gated on to cause the mixer to generate the mixed audio signal with an attenuated version of the audio signal of the channel initially gated on.

23. The method of claim 22, further comprising based on determining that the non-speech audio is present in the audio signal of the channel initially gated on, attenuating the audio signal of the channel initially gated on to generate the attenuated version of the audio signal of the channel initially gated on.

24. The method of claim 22, wherein overriding the mixer comprises overriding the mixer by controlling a rate of gating off the channel initially gated on.

25. The method of claim 24, wherein controlling the rate of gating off the channel initially gated on comprises applying a ramp for gating off the channel initially gated on.

26. The method of claim 25, wherein applying the ramp comprises altering a slope of the ramp for gating off the channel initially gated on.

27. The method of claim 22, further comprising minimizing front end noise leak in the audio signal of the channel initially gated on during a time duration between (1) the mixer determining to gate on the channel initially gated on and (2) determining whether the non-speech audio is present in the audio signal of the channel initially gated on.

28. The method of claim 22, further comprising:
applying a non-speech de-emphasis filter to the audio signal of the channel initially gated on;
determining whether speech audio is present in the audio signal of the channel initially gated on; and
based on determining that the speech audio is present in the audio signal of the channel initially gated on, removing the non-speech de-emphasis filter from the audio signal of the channel initially gated on.

29. The method of claim 22, further comprising:
attenuating the audio signal of the channel initially gated on;
determining whether speech audio is present in the audio signal of the channel initially gated on; and
based on determining that the speech audio is present in the audio signal of the channel initially gated on, removing the attenuation from the audio signal of the channel initially gated on.

30. The method of claim 22, further comprising:
applying a time varying attenuation to the audio signal of the channel initially gated on;
determining whether speech audio is present in the audio signal of the channel initially gated on; and
based on determining that the speech audio is present in the audio signal of the channel initially gated on, removing the time varying attenuation from the audio signal of the channel initially gated on.

31. The method of claim 22, further comprising:
applying one or more of a crest factor compressor or a crest factor limiter to the audio signal of the channel initially gated on;
determining whether speech audio is present in the audio signal of the channel initially gated on; and
based on determining that the speech audio is present in the audio signal of the channel initially gated on, removing the one or more of the crest factor compressor or the crest factor limiter from the audio signal of the channel initially gated on.

32. The method of claim 22, further comprising:
determining whether speech audio is present in the audio signal of the channel initially gated on;
determining whether non-speech audio is present in a second audio signal of a second channel initially gated on by the mixer; and
based on determining that the speech audio is present in the audio signal of the channel initially gated on and based on determining that the non-speech audio is present in the second audio signal of the second channel initially gated on, applying a noise leakage filter to the audio signal of the channel initially gated on.

33. A system, comprising:
an activity detector configured to determine whether non-speech audio is present in an audio signal of a channel initially gated on by a mixer, wherein the mixer is configured to generate a mixed audio signal based on at least the audio signal of the channel initially gated on; and
a channel gating module in communication with the activity detector, the channel gating module configured to, based on the activity detector determining that the non-speech audio is present in the audio signal of the channel initially gated on, override the mixer to cause the mixer to:
gate off the channel initially gated on; and
generate the mixed audio signal with an attenuated version of the audio signal of the channel initially gated on.

34. The system of claim 33, wherein the channel gating module is further configured to, based on the activity detector determining that the non-speech audio is present in the audio signal of the channel initially gated on, attenuate the audio signal of the channel initially gated on to generate the attenuated version of the audio signal of the channel initially gated on.

35. The system of claim 33, wherein the channel gating module is configured to, based on the activity detector determining that the non-speech audio is present in the audio signal of the channel initially gated on, override the mixer to cause the mixer to gate off the channel initially gated on by controlling a rate of gating off the channel initially gated on.

36. The system of claim 33, further comprising a pre-mixer in communication with the mixer, the pre-mixer configured to minimize front end noise leak in the audio signal of the channel initially gated on during a time duration between (1) the mixer determining to gate on the channel initially gated on and (2) the activity detector determining whether the non-speech audio is present in the audio signal of the channel initially gated on.

37. The system of claim 33,
wherein the activity detector is further configured to determine whether speech audio is present in the audio signal of the channel initially gated on; and
further comprising a non-speech de-emphasis filter configured to:
filter the audio signal of the channel initially gated on; and
based on the activity detector determining that the speech audio is present in the audio signal of the channel initially gated on, cease filtering of the audio signal of the channel initially gated on.

38. The system of claim 33,
wherein the activity detector is further configured to determine whether speech audio is present in the audio signal of the channel initially gated on; and
wherein the channel gating module is further configured to:
attenuate the audio signal of the channel initially gated on; and
based on the activity detector determining that the speech audio is present in the audio signal of the channel initially gated on, cease attenuating the audio signal of the channel initially gated on.

39. The system of claim 33,
wherein the activity detector is further configured to determine whether speech audio is present in the audio signal of the channel initially gated on; and
wherein the channel gating module is further configured to:
apply a time varying attenuation to the audio signal of the channel initially gated on; and
based on the activity detector determining that the speech audio is present in the audio signal of the channel initially gated on, remove the time varying attenuation from the audio signal of the channel initially gated on.

40. The system of claim 33,
wherein the activity detector is further configured to determine whether speech audio is present in the audio signal of the channel initially gated on; and
wherein the channel gating module is further configured to:
apply one or more of a crest factor compressor or a crest factor limiter to the audio signal of the channel initially gated on; and
based on the activity detector determining that the speech audio is present in the audio signal of the channel initially gated on, remove the one or more of the crest factor compressor or the crest factor limiter from the audio signal of the channel initially gated on.

41. The system of claim 33,
wherein the activity detector is further configured to determine:
whether speech audio is present in the audio signal of the channel initially gated on; and
whether non-speech audio is present in a second audio signal of a second channel initially gated on by the mixer; and
further comprising a pre-mixer in communication with the mixer, the pre-mixer configured to:
based on the activity detector determining that the speech audio is present in the audio signal of the channel initially gated on and based on the activity detector determining that the non-speech audio is present in the second audio signal of the second channel initially gated on, apply a noise leakage filter to the audio signal of the channel initially gated on.
